(19) United States
(12) Patent Application Publication
(10) Pub. No.: US 2026/0233748 A1
(43) Pub. Date: Aug. 13, 2026

(54) ADAPTIVE NOTIFICATIONS IN AUTOMATED DRIVING

(71) Applicant: GM Global Technology Operations LLC, Detroit, MI (US)

(72) Inventors: Yuan Zhang, Pudong (CN); XuanRun Wan, Shanghai (CN)

(21) Appl. No.: 19/058,249

(22) Filed: Feb. 20, 2025

(30) Foreign Application Priority Data
Feb. 8, 2025 (CN) 202510144707.8

(51) Int. Cl. B60W 50/14; B60K 35/23; B60K 35/28; B60W 40/08; B60W 50/00; B60W 60/00

(52) U.S. Cl. CPC B60W 50/14; B60K 35/23; B60K 35/28; B60W 40/08; B60W 50/0097; B60W 60/0051; B60K 2360/172; B60K 2360/1868; B60K 2360/188; B60K 2360/785; B60W 2040/089; B60W 2050/0083; B60W 2050/143; B60W 2050/146; B60W 2540/21; B60W 2540/223; B60W 2556/10; B60W 2556/20

(57) ABSTRACT

A method of providing notifications and vehicle control within a subject vehicle in response to detected traffic situations includes collecting real-time data related to a traffic situation located ahead of the subject vehicle and operating conditions of the vehicle, determining that display of an informational notification is appropriate and displaying, via a human machine interface, the informational notification, and determining that display of an action notification is appropriate and displaying, via the human machine interface, the action notification.

### INTRODUCTION

The present disclosure relates to a system and method for providing informational notifications and action notifications when a traffic system is detected ahead of a subject vehicle.

Current systems within vehicle are adapted to detect object, such as slow-moving vehicle, potholes, etc. within the roadway ahead of a vehicle traveling on the roadway. It would be advantageous for the system to provide an information notification alerting a driver of the subject vehicle to the presence of a detected traffic situation and further, to provide an action notification describing action to be taken in response to the detected traffic situation.

Thus, while current systems and methods achieve their intended purpose, there is a need for a new and improved system and method for providing an informational notification adapted to inform a driver of a subject vehicle when a traffic situation is detected, wherein the system calculates a confidence level that action will need to be taken in response to the detected traffic situation and displays the informational notification in a manner that conveys such confidence level, and an action notification adapted to direct the driver or inform the driver of an action that should or will be taken in response to the detected traffic situation, wherein the system calculates a confidence level that the action must be taken and displays the action notification in a manner that conveys such confidence level.

### SUMMARY

According to several aspects of the present disclosure, a method of providing notifications and vehicle control within a subject vehicle in response to detected traffic situations includes collecting, with a plurality of onboard sensors in communication with a system controller, real-time data related to a traffic situation located ahead of the subject vehicle and operating conditions of the vehicle, determining, with the system controller, that display of an informational notification is appropriate, wherein the informational notification is adapted to provide information to a driver of the subject vehicle related to the traffic situation, displaying, with the system controller, via a human machine interface, the informational notification, determining, with the system controller, that display of an action notification is appropriate, wherein the action notification is adapted to at least one of inform the driver of autonomous action that will be taken in response to the traffic situation, and direct the driver to take action in response to the traffic situation, and displaying, with the system controller, via the human machine interface, the action notification.

According to another aspect, the determining, with the system controller, that display of the informational notification is appropriate further includes accessing, with the system controller, a machine learning model based on driver preferences and data collected from past instances of detection of traffic situations, display of informational notifications, display of action notifications and driver responses to displayed informational notifications and action notifications, and predicting, with the machine learning model within the system controller, that an informational notification is appropriate based on the real-time data related to the traffic situation located ahead of the subject vehicle and operating conditions of the subject vehicle.

According to another aspect, the displaying, with the system controller, via the human machine interface, the informational notification further includes calculating a probabilistic confidence level that the traffic situation will require a responsive maneuver by the subject vehicle, and including color coding and graphics within the informational notification based on the calculated probabilistic confidence level that the traffic situation will require a responsive maneuver by the subject vehicle.

According to another aspect, the displaying, with the system controller, via the human machine interface, the informational notification further includes displaying the informational notification including a description of the traffic situation and a distance to the traffic situation.

According to another aspect, the displaying, with the system controller, via the human machine interface, the informational notification further includes monitoring, with an driver monitoring system in communication with the system controller, acknowledgment, by the driver of the subject vehicle, of the displayed informational notification, and if the driver of the subject vehicle does not acknowledge the displayed informational notification, augmenting the displayed informational notification.

According to another aspect, the monitoring, with an driver monitoring system in communication with the system controller, acknowledgment, by the driver of the subject vehicle, of the displayed informational notification further includes, monitoring, with the driver monitoring system, head movements and hand gestures by the driver of the subject vehicle, verbal acknowledgment by the driver of the subject vehicle, and alterations, by the driver of the subject vehicle, to vehicle operating conditions including, but not limited to, steering angle, braking and acceleration.

According to another aspect, the determining, with the system controller, that display of an action notification is appropriate further includes accessing, with the system controller, the machine learning model based on driver preferences and data collected from past instances of detection of traffic situations, display of informational notifications, display of action notifications and driver responses to displayed informational notifications and action notifications, and predicting, with the machine learning model that an action notification is appropriate based on the real-time data related to the traffic situation located ahead of the subject vehicle and operating conditions of the vehicle.

According to another aspect, the displaying, with the system controller, via the human machine interface, the action notification further includes calculating a probabilistic confidence level that an immediate responsive maneuver by the subject vehicle in response to the traffic situation is required, and including color coding and graphics within the action notification based on the calculated probabilistic confidence level that an immediate responsive maneuver by the subject vehicle in response to the traffic situation is required.

According to another aspect, the displaying, with the system controller, via the human machine interface, the action notification further includes displaying the action notification including a textual and graphical description of the required responsive maneuver.

According to another aspect, the displaying, with the system controller, via the human machine interface, the action notification further includes monitoring, with the driver monitoring system and the plurality of sensors within the subject vehicle, action taken in response to the displayed action notification, and if the driver of the subject vehicle does not take action in response to the displayed action notification, augmenting the displayed action notification.

According to another aspect, the monitoring, with the driver monitoring system and the plurality of sensors within the subject vehicle, action taken in response to the displayed action notification further includes, monitoring, with the driver monitoring system, head movements and hand gestures by the driver of the subject vehicle, verbal acknowledgment by the driver of the subject vehicle, and alterations, by the driver of the subject vehicle, to vehicle operating conditions including, but not limited to, steering angle, braking and acceleration.

According to another aspect, the method further includes when the driver of the subject vehicle does not take action in response to the displayed action notification and the subject vehicle is being operated in a manual mode of operation, initiating, with the system controller, via an automatic driving assistance system, autonomous take-over of the subject vehicle, and performing, with the system controller, via the automatic driving assistance system, a responsive maneuver in response to the traffic situation.

According to another aspect, the method further includes, when the driver of the subject vehicle does not take action in response to the displayed action notification and the subject vehicle is being operated in an autonomous mode of operation, performing, with the system controller, via the automatic driving assistance system, a responsive maneuver in response to the traffic situation.

According to several aspects of the present disclosure, a system for providing notifications and vehicle control within a subject vehicle in response to detected traffic situations includes a system controller, a plurality of onboard sensors in communication with the system controller and adapted to collect real-time data related to a traffic situation located ahead of the subject vehicle and operating conditions of the vehicle, the system controller adapted to determine that display of an informational notification is appropriate, wherein the informational notification is adapted to provide information to a driver of the subject vehicle related to the traffic situation, display, via a human machine interface, the informational notification, determine that display of an action notification is appropriate, wherein the action notification is adapted to at least one of inform the driver of autonomous action that will be taken in response to the traffic situation, and direct the driver to take action in response to the traffic situation, and display, via the human machine interface, the action notification.

According to another aspect, when determining that display of the informational notification is appropriate, the system controller is further adapted to access a machine learning model based on driver preferences and data collected from past instances of detection of traffic situations, display of informational notifications, display of action notifications and driver responses to displayed informational notifications and action notifications, and predict, with the machine learning model within the system controller, that an informational notification is appropriate based on the real-time data related to the traffic situation located ahead of the subject vehicle and operating conditions of the subject vehicle.

According to another aspect, when displaying, via the human machine interface, the informational notification, the system controller is further adapted to calculate a probabilistic confidence level that the traffic situation will require a responsive maneuver by the subject vehicle, include color coding and graphics within the informational notification based on the calculated probabilistic confidence level that the traffic situation will require a responsive maneuver by the subject vehicle and including a description of the traffic situation and a distance to the traffic situation, monitor, with a driver monitoring system in communication with the system controller, acknowledgment, by the driver of the subject vehicle, of the displayed informational notification including head movements and hand gestures by the driver of the subject vehicle, verbal acknowledgment by the driver of the subject vehicle, and alterations, by the driver of the subject vehicle, to vehicle operating conditions including, but not limited to, steering angle, braking and acceleration, and if the driver of the subject vehicle does not acknowledge the displayed informational notification, augment the displayed informational notification.

According to another aspect, when determining that display of an action notification is appropriate, the system controller is further adapted to access the machine learning model, and predict, with the machine learning model that an action notification is appropriate based on the real-time data related to the traffic situation located ahead of the subject vehicle and operating conditions of the vehicle.

According to another aspect, when displaying, via the human machine interface, the action notification, the system controller is further adapted to calculate a probabilistic confidence level that an immediate responsive maneuver by the subject vehicle in response to the traffic situation is required, include color coding and graphics within the action notification based on the calculated probabilistic confidence level that an immediate responsive maneuver by the subject vehicle in response to the traffic situation is required and including a textual and graphical description of the required responsive maneuver, monitor, with the driver monitoring system and the plurality of sensors within the subject vehicle, action taken in response to the displayed action notification including head movements and hand gestures by the driver of the subject vehicle, verbal acknowledgment by the driver of the subject vehicle, and alterations, by the driver of the subject vehicle, to vehicle operating conditions including, but not limited to, steering angle, braking and acceleration, and if the driver of the subject vehicle does not take action in response to the displayed action notification, augment the displayed action notification.

According to still another aspect of the present disclosure, when the driver of the subject vehicle does not take action in response to the displayed action notification and the subject vehicle is being operated in a manual mode of operation the system controller is further adapted to initiate, via an automatic driving assistance system, autonomous take-over of the subject vehicle, and perform, via the automatic driving assistance system, a responsive maneuver in response to the traffic situation, and, when the driver of the subject vehicle does not take action in response to the displayed action notification and the subject vehicle is being operated in an autonomous mode of operation the system controller is further adapted to perform, via the automatic driving assistance system, a responsive maneuver in response to the traffic situation.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle having a system for providing informational notifications and action notifications in response to detected traffic situations according to an exemplary embodiment;

FIG. 2 is a schematic diagram of the system according to an exemplary embodiment;

FIG. 3 is a schematic diagram illustrating a subject vehicle traveling on a roadway wherein a pothole is present within the lane ahead of the subject vehicle;

FIG. 4 is a schematic diagram illustrating a subject vehicle traveling on a roadway wherein a slow-moving truck is present within the lane ahead of the subject vehicle;

FIG. 5 is a schematic graphic of an interior of the subject vehicle shown in FIG. 1;

FIG. 6A is an informational notification indicating that a pothole is present ahead of the subject vehicle at a distance of 200 meters;

FIG. 6B is an informational notification indicating that a slow-moving vehicle is present ahead of the subject vehicle at a distance of 200 meters;

FIG. 7A is the informational notification shown in FIG. 6A including an action notification indicating that the subject vehicle can proceed straight forward;

FIG. 7B is the informational notification shown in FIG. 6A including an action notification indicating that it might be appropriate for the subject vehicle to change lanes to avoid the pothole ahead of the subject vehicle;

FIG. 7C is the informational notification shown in FIG. 6A including an action notification indicating that a lane change to avoid the pothole ahead of the subject vehicle is required;

FIG. 7D is the informational notification shown in FIG. 6B including an action notification indicating that a lane change to avoid the slow-moving vehicle ahead of the subject vehicle is required; and

FIG. 8 is a flow chart illustrating a method according to an exemplary embodiment.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

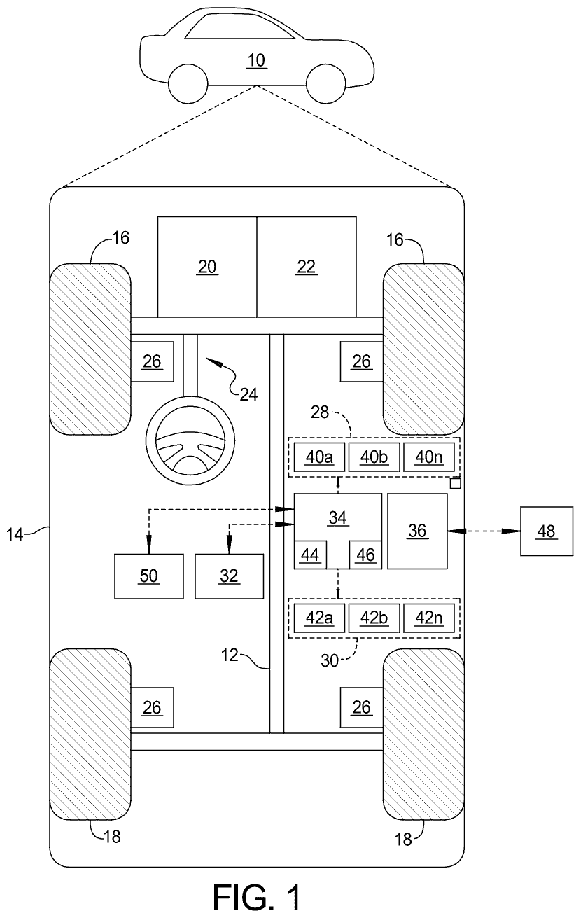

In accordance with an exemplary embodiment, FIG. 1 shows a subject vehicle 10 with an associated system 50 for providing notifications and vehicle control. In general, the system 50 works in conjunction with other systems within the subject vehicle 10 to display various information for a driver of the subject vehicle 10 and initiate autonomous vehicle maneuvers in response to detection of a traffic situation ahead of the subject vehicle 10. The subject vehicle 10 generally includes a chassis 12, a body 14, front wheels 16, and rear wheels 18. The body 14 is arranged on the chassis 12 and substantially encloses components of the subject vehicle 10. The body 14 and the chassis 12 may jointly form a frame. The front wheels 16 and rear wheels 18 are each rotationally coupled to the chassis 12 near a respective corner of the body 14.

In various embodiments, the subject vehicle 10 is an autonomous vehicle and the system 50 is incorporated into the autonomous vehicle 10 and communicates with an autonomous vehicle control module 52 of an automatic driver assistance system (ADAS) 54. An autonomous vehicle 10 is, for example, a vehicle 10 that is automatically controlled to carry passengers from one location to another. The subject vehicle 10 is depicted in the illustrated embodiment as a passenger car, but it should be appreciated that any other vehicle including motorcycles, trucks, sport utility vehicles (SUVs), recreational vehicles (RVs), etc., can also be used. In an exemplary embodiment, the subject vehicle 10 is equipped with a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. The novel aspects of the present disclosure are also applicable to non-autonomous vehicles.

As shown, the subject vehicle 10 generally includes a propulsion system 20, a transmission system 22, a steering system 24, a brake system 26, a sensor system 28, an actuator system 30, at least one data storage device 32, a system controller 34, and a wireless communication module 36. In an embodiment in which the subject vehicle 10 is an electric vehicle, there may be no transmission system 22. The propulsion system 20 may, in various embodiments, include an internal combustion engine, an electric machine such as a traction motor, and/or a fuel cell propulsion system. The transmission system 22 is configured to transmit power from the propulsion system 20 to the vehicle's front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle's front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the subject vehicle 10. The sensing devices 40a-40n can include, but are not limited to, radars, lidars, global positioning systems, optical cameras, thermal cameras, ultrasonic sensors, and/or other sensors. The cameras can include two or more digital cameras spaced at a selected distance from each other, in which the two or more digital cameras are used to obtain stereoscopic images of the surrounding environment in order to obtain a three-dimensional image or map. The plurality of sensing devices 40a-40n is used to determine information about an environment surrounding the vehicle 10. In an exemplary embodiment, the plurality of sensing devices 40a-40n includes at least one of a motor speed sensor, a motor torque sensor, an electric drive motor voltage and/or current sensor, an accelerator pedal position sensor, a coolant temperature sensor, a cooling fan speed sensor, and a transmission oil temperature sensor. In another exemplary embodiment, the plurality of sensing devices 40a-40n further includes sensors to determine information about the environment surrounding the vehicle 10, for example, an ambient air temperature sensor, a barometric pressure sensor, and/or a photo and/or video camera which is positioned to view the environment in front of the vehicle 10. In another exemplary embodiment, at least one of the plurality of sensing devices 40a-40n is capable of measuring distances in the environment surrounding the vehicle 10.

In a non-limiting example wherein the plurality of sensing devices 40a-40n includes a camera, the plurality of sensing devices 40a-40n measures distances using an image processing algorithm configured to process images from the camera and determine distances between objects. In another non-limiting example, the plurality of vehicle sensors 40a-40n includes a stereoscopic camera having distance measurement capabilities. In one example, at least one of the plurality of sensing devices 40a-40n is affixed inside of the vehicle 10, for example, in a headliner of the vehicle 10, having a view through the windshield of the vehicle 10. In another example, at least one of the plurality of sensing devices 40a-40n is affixed outside of the vehicle 10, for example, on a roof of the vehicle 10, having a view of the environment surrounding the vehicle 10. It should be understood that various additional types of sensing devices, such as, for example, LiDAR sensors, ultrasonic ranging sensors, radar sensors, and/or time-of-flight sensors are within the scope of the present disclosure. The actuator system 30 includes one or more actuator devices 42a-42n that control one or more vehicle 10 features such as, but not limited to, the propulsion system 20, the transmission system 22, the steering system 24, and the brake system 26.

The system 50 includes a driver monitoring system 56 that receives data from at least one camera includes within the plurality of sensors 40a-40n. The driver monitoring system 56 is adapted to detect movements of the driver's head and eyes to determine a direction which the driver is looking and to what the driver is looking at. The driver monitoring system 56 is further adapted to monitor gestures made by the driver using either head movements, such as nodding, or hand gestures.

The system controller 34 includes at least one processor 44 and a computer readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the system controller 34 in controlling the subject vehicle 10 and the system 50.

The instructions may include one or more separate programs, each of which includes an ordered listing of executable instructions for implementing logical functions. The instructions, when executed by the at least one processor 44, receive and process signals from the sensor system 28, perform logic, calculations, methods and/or algorithms for automatically controlling the components of the subject vehicle 10, and generate control signals to the actuator system 30 to automatically control the components of the subject vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10. The system controller 34 may be the primary vehicle controller, or the system controller 34 may be a separate controller in communication with a primary vehicle controller.

In various embodiments, one or more instructions of the system controller 34 are embodied in a trajectory planning system and, when executed by the at least one data processor 44, generates a trajectory output that addresses kinematic and dynamic constraints of the environment. For example, the instructions receive as input process sensor and map data. The instructions perform a graph-based approach with a customized cost function to handle different road scenarios in both urban and highway roads.

The wireless communication module 36 is configured to wirelessly communicate information to and from other remote entities 48, such as but not limited to, other vehicles (“V2V” communication,) infrastructure (“V2I” communication), remote systems, remote servers, cloud computers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The system controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

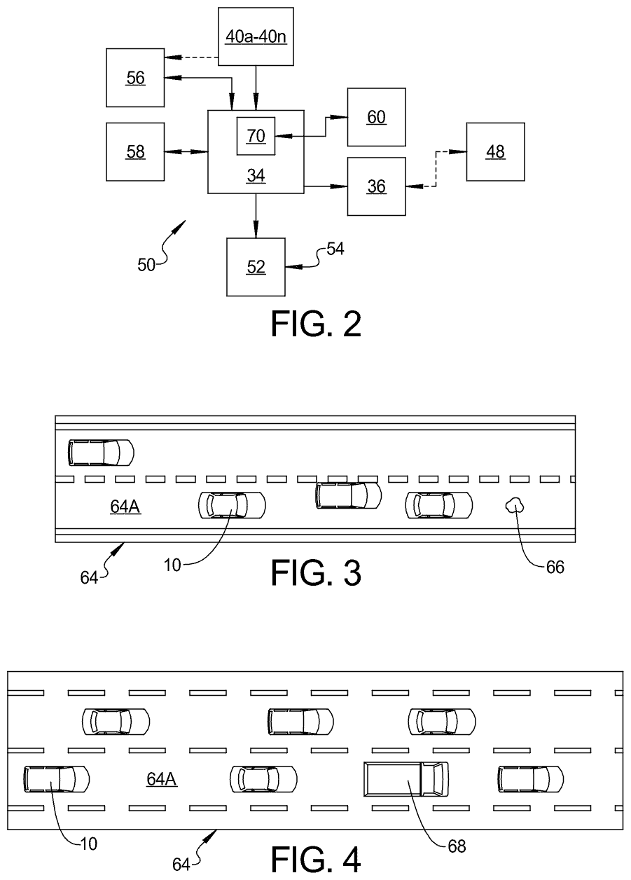

Referring to FIG. 2 a schematic diagram of the system 50 is shown. The system 50 includes the system controller 34 in communication with the plurality of sensing devices (onboard sensors) 40a-40n. In addition to the plurality of onboard sensors 40a-40n, the system controller 34 is in communication with a human machine interface (HMI) 58, the autonomous vehicle control module 52, a database 60 and the wireless communication module 36.

The system controller 34, via communication with the plurality of onboard sensors 40a-40n is adapted to collect real-time data related to a location of the subject vehicle 10 and operating conditions of the subject vehicle 10. The database 60 is in communication with the system controller 34 and is adapted to store data related to past maneuvers taken by the subject vehicle 10 in response to detection, by the system controller 34 and the plurality of sensors 40a-40n of traffic situations and operating conditions of the subject vehicle 10 when such past maneuvers occurred. Past maneuvers may include manual or autonomous lane changes or slowing of the subject vehicle 10 in response to detection of a slow-moving vehicle or object (animal, road defect, fallen tree, etc.) within a lane directly ahead of the subject vehicle 10. The database 60 stores occurrences of such maneuvers as well as data related to the location of the subject vehicle 10 and operating conditions such as weather, speed, presence and position of other vehicles in proximity to the subject vehicle 10, etc., when such maneuvers occurred.

In an exemplary embodiment, the system controller 34 is adapted to collect, with the plurality of sensors 40a-40n, real-time data related to a traffic situation located ahead of the subject vehicle 10 and operating conditions of the subject vehicle 10, whereupon, the system controller 34 determines if display of an informational notification 62 is appropriate. The informational notification 62 is a message including text and/or graphics displayed on the HMI 58 for the driver of the subject vehicle 10 to provide information to the driver of the subject vehicle 10 related to the traffic situation. The system controller 34 displays the informational notification 62 on the HMI 58 to provide notification to the driver of the presence of the traffic situation.

The HMI 58 may include a touch screen display screen on which the informational notification 62 and other information is displayed for the driver, wherein the driver is capable of interacting with the system 50 via interaction with the touch screen and/or through verbal inputs picked up by a microphone 84 associated with the HMI 58. In an exemplary embodiment, the HMI 58 is associated with a head-up-display within the subject vehicle 10 and in communication with the system controller 34, wherein the system controller 34 can utilize the head-up-display to display the informational notification 62 onto an inner surface of the windshield of the subject vehicle 10 in addition to displaying the informational notification on the HMI 58.

Referring to FIG. 3, the subject vehicle 10 is moving within a right lane 64A within a roadway 64 and the system controller 34 detects, with the plurality of sensors 40a-40n, the presence of a pothole 66 within the right lane 64A within the path of the subject vehicle 10. Referring to FIG. 4, the subject vehicle 10 is moving within the right lane 64A of the roadway 64, and the system controller 34 detects, with the plurality of sensors 40a-40n, the presence of a slow-moving truck 68 within the right lane 64A within the path of the subject vehicle 10.

The system controller 34 uses data stored within the data base 60, real-time data of current operating conditions of the subject vehicle 10 and the location of the subject vehicle 10 relative to the pothole 66 to determine if displaying the informational notification 62 is appropriate. In an exemplary embodiment, the system controller 34 is adapted to access a machine learning model 70 that is based on driver preferences and data collected from past instances of detection of traffic situations, display of informational notifications 62 and driver responses to displayed informational notifications 62. The machine learning model 70 is adapted to predict that an informational notification 62 is appropriate based on the real-time data related to the traffic situation (pothole 66, slow-moving truck 68) located ahead of the subject vehicle 10 and operating conditions of the subject vehicle 10.

Determination that the informational notification 62 is appropriate can be based on a probabilistic calculation by the machine learning model 70 that the detected traffic situation (pothole 66, slow-moving truck 68) will interfere with the current trajectory of the subject vehicle 10, and thus, may necessitate a vehicle maneuver to avoid the traffic situation. For example, when the system controller 34 detects the pothole 66 in FIG. 3, the machine learning model 68 uses data to calculate a probability that the driver of the subject vehicle 10 will want to avoid hitting the pothole based on past behavior of that driver encountering such a traffic situation. Further, the system controller 34 receives information from remote entities 48, such as department of transportation databases, wherein the system controller 34 can determine that the informational notification 62 is appropriate based on information that the pothole 66 is causing damage to vehicles that have hit the pothole 66.

Various techniques are employed to extract meaningful features from sensor readings and data, including time-series analysis, frequency-domain analysis, and spatial-temporal patterns. The machine learning model 70 may be one of, but not limited to, Long Short-Term Memory (LSTM), Gated Recurrent Unit (GRU), Decision Trees, Random Forests, Support Vector Machines (SVM), Neural Networks (NN), K-Nearest Neighbors (KNN), Gradient Boosting and Recurrent Neural Networks (RNN).

Thus, the system controller 34 uses the machine learning model 70 and machine learning techniques to predict a desired action that the driver of the subject vehicle 10 will take based on analyzing the real-time data of the location of the subject vehicle 10 and the operating conditions of the subject vehicle 10 in light of data received from the database 60 including past maneuvers and the locations and operating conditions of the subject vehicle 10 when traffic situations identical or similar to the detected traffic situation (pothole 66, slow-moving truck 68) occurred in the past.

Occupants within a vehicle often engage in repeated patterns. Observation of such patterns allows the machine learning model 70 to establish a pattern of behavior, and to predict future behavior based on such patterns. This allows the machine learning model 70 to determine if and when an informational notification 62 is appropriate.

To create the machine learning model 70, first a generic machine learning model is trained with data collected from a plurality of different vehicles located in a region and climate similar to the subject vehicle 10. A diverse dataset is collected from vehicles equipped with sensors such as GPS, accelerometers, cameras, radar, and LIDAR. The data encompasses various driving scenarios, including urban, highway, and off-road driving. Before feeding the data into machine learning models, preprocessing steps are undertaken to remove noise, handle missing values, and standardize features. An essential step in driving behavior classification is the extraction of relevant features from the raw data. As mentioned above, various techniques are employed to extract meaningful features from sensor readings, including time-series analysis, frequency-domain analysis, and spatial-temporal patterns. Different types of machine learning algorithms may be used for probabilistic identification of patterns, including but not limited to Long Short-Term Memory (LSTM), Gated Recurrent Unit (GRU), Decision Trees, Random Forests, Support Vector Machines (SVM), Neural Networks (NN), K-Nearest Neighbors (KNN), Gradient Boosting and Recurrent Neural Networks (RNN). The generic machine learning model is trained on a labeled dataset and evaluated using various performance metrics such as accuracy, precision, recall, F1-score, and confusion matrix. The hyperparameters of the models are tuned to achieve optimal results. The generic machine learning model is trained on training data and will learn to map input features to the corresponding pattern (actions) probabilities.

The generic machine learning model is uploaded to the system controller 34 within the subject vehicle 10. The generic machine learning model provides a basis for creation of driver specific profiles and the machine learning model 70 for the specific driver of the subject vehicle 10. The upload of the generic machine learning model may be via a subscription-based service from a third-party provider or the subject vehicle 10 manufacturer. The machine learning model 70 is ultimately created by updating the generic machine learning model. Once the generic machine learning model is uploaded, data is collected as the driver of the subject vehicle 10 uses the subject vehicle 10 day to day. As the driver uses the subject vehicle 10, the generic machine learning model is updated to personalize the generic machine learning model to the specific driver of the subject vehicle 10, thus creating the machine learning model 70, which is tailored for the specific driver of the subject vehicle 10 and is also continuously updated. The system controller 34 may have multiple machine learning models stored therein, each one tailored for a specific driver, and any time a new driver of the subject vehicle 10 is identified by the system controller 34, via the driver monitoring system 56, the system controller 34 will begin customizing a copy of the generic machine learning model, creating a unique machine learning model for that driver.

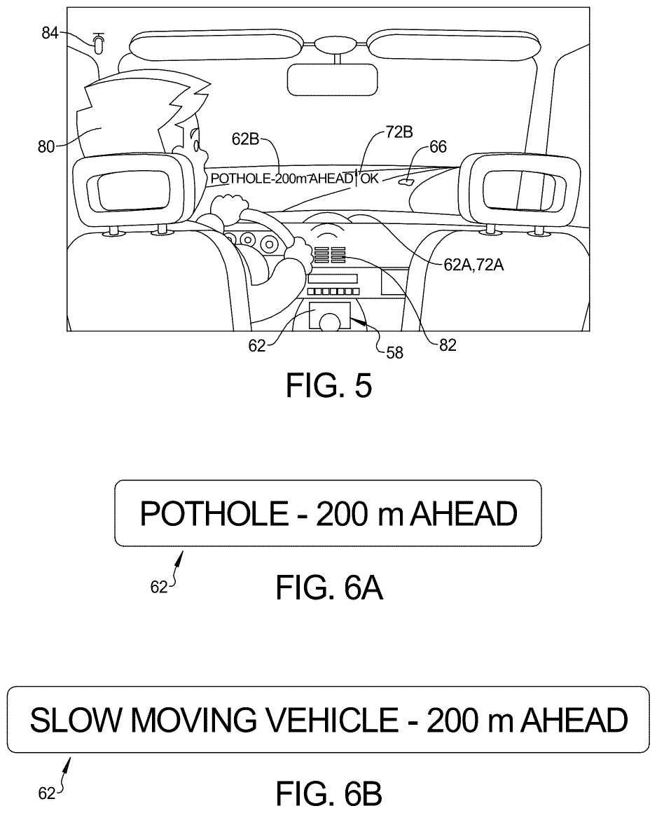

Referring to FIG. 5 and FIG. 6A, the system controller 34 displays an informational notification 62 adapted to inform the driver 80 of the subject vehicle 10 of the presence of the traffic situation (pothole 66, slow-moving truck) on a display screen of the HMI 58. The purpose of the informational notification 62 is to inform the driver 80 of the subject vehicle 10 to the presence of the traffic situation. In an exemplary embodiment, the informational notification 62 includes a description of the traffic situation and a distance to the traffic situation. Referring to FIG. 6A, the displayed informational notification 62 includes a description of the traffic situation, “Pothole”, and provides a distance “200 m ahead”, to the pothole 66. Upon receiving the informational notification, the driver of the subject vehicle 10 is informed of the traffic situation and can either prepare to take action based on the presence of the traffic situation, or be reassured that no action is necessary. Referring to FIG. 6B, a displayed informational notification 62 for the slow-moving truck 68 includes a description of the traffic situation, “Slow-Moving Vehicle”, and provides a distance “200 m ahead”, to the slow-moving truck 68.

When displaying, via the human machine interface 58, the informational notification 62, the system controller 34 is further adapted to calculate a probabilistic confidence level that the traffic situation will require a responsive maneuver by the subject vehicle 10. The displayed informational notification 62 includes color coding and graphics within the informational notification 62 based on the calculated probabilistic confidence level that the traffic situation will require a responsive maneuver by the subject vehicle 10. For example, if the confidence level is low, the informational notification 62 may be displayed in GREEN, indicating to the driver 80 of the subject vehicle 10 that the traffic situation does not pose an imminent issue. If the confidence level is medium, the informational notification 62 may be displayed in YELLOW, indicating to the driver 80 of the subject vehicle 10 that the traffic situation is more likely to require a maneuver, thus, informing the driver 80 to be prepared for such a maneuver. Finally, if the confidence level is high, the informational notification 62 may be displayed in RED, alerting the driver 80 to the traffic situation and conveying some urgency prompting the driver to begin preparation for a maneuver to avoid the traffic situation. The colors may be selectively changed by the driver 80 to their preferences.

A first step in calculating a confidence level for the informational notification 62 includes calculating a probability that the traffic situation will require a maneuver to avoid the traffic situation. Thus, referring again to the example with the pothole 66 discussed above, when the system controller 34 first detects the pothole 66 and determines that the informational notification 62 is appropriate, the distance to the pothole 66 may be large, or alternatively, information received from remote entities 48 may indicate that the pothole 66 is a minor obstruction, wherein the system controller 34 probabilistically calculates a low confidence level that the pothole 66 will require a responsive maneuver by the subject vehicle 10, and displays the informational notification 62 “Pothole—200 m Ahead” in GREEN letters and graphics. If the confidence level changes, as the subject vehicle 10 gets closer, the color of the informational notification may change. Referring to the example with the slow-moving truck 68 discussed above, if the system controller 34 detects that the slow-moving truck 68 is moving significantly slower than the subject vehicle 10, then there is a high confidence level that the subject vehicle 10 will need to make a maneuver to avoid the slow-moving truck 68, such as changing lanes to go around the slow-moving truck 68. Alternatively, if the system controller 34 detects that the slow-moving truck 68 is moving only slightly slower than the subject vehicle 10, then there is a lower confidence level that the subject vehicle 10 will need to make a maneuver.

A second step in calculating a confidence level for the informational notification 62 includes calculating probabilities to predict if and when the driver 80 of the subject vehicle 10 will take action. The system controller 34 uses the machine learning model 70 to analyze past instances of the driver 80 of the subject vehicle 10 encountering such traffic situation and to predict what action that driver 80 will want to take in response to the traffic situation and when the driver 80 of the subject vehicle 10 will take action in calculating the confidence level. For example, for a first driver of the subject vehicle 10, the database 60 includes data from past instances of the first driver encountering the pothole 66, and in previous instances, the first driver does not take action or perform a maneuver to avoid the pothole 66, and simply drives over the pothole 66. Thus, the system controller 34, using a machine learning model tailored for the first driver, calculates a low confidence level that a maneuver will be necessary or preferred by the first driver and displays an information notification 62 in GREEN text to indicate such. Alternatively, for a second driver of the subject vehicle 10, the database 60 includes data from past instances of the second driver encountering the pothole 66, and in previous instances, the second driver elects to change lanes to avoid the pothole 66 at a distance no less than 200 meters from the pothole 66. Thus, the system controller 34, using a machine learning model tailored for the second driver calculates a high confidence level that a maneuver will be necessary or preferred by the second driver and displays an information notification 62 in RED text to indicate such. In this way, the system controller 34, using data stored for various drivers and machine learning models tailored for the various drivers provides the information notification 62 in a manner that is consistent with the driver's past behavior and preferences.

In an exemplary embodiment, when displaying the informational notification 62, the system controller 34 further provides an audible notification 62A via a speaker 82 associated with the HMI 58. The audible notification 62A may be a chime or bell adapted to alert the driver 80 of the subject vehicle 10 that the informational notification 62 has been displayed on the HMI 58, and prompting the driver 80 of the subject vehicle 10 to look at the HMI 58 to read the informational notification 62. The audible notification 62A may further be an audible message mirroring the displayed informational notification 62, wherein a computer synthesized voice saying “Pothole, 200 meters ahead” is broadcast for the driver 80 of the subject vehicle 10.

In another exemplary embodiment, when the informational notification 62 is displayed on the HMI 58, the system controller further displays the informational notification 62B onto the inner surface of the windshield of the subject vehicle 10 with the head-up-display.

Once the informational notification 62 has been displayed, the system controller 34 is adapted to monitor, with the driver monitoring system 56, acknowledgment, by the driver of the subject vehicle 10, of the displayed informational notification 62. Using cameras, microphones and sensors included within the plurality of sensors 40a-40n and associated with the driver monitoring system 56, the system controller 34 “looks” for actions by the driver 80 of the subject vehicle 10 that indicate the driver 80 of the subject vehicle 10 has seen and reacted to the informational notification 62. The system controller 34, using the driver monitoring system 56 detects head movements and hand gestures by the driver of the subject vehicle 10, verbal acknowledgment by the driver of the subject vehicle 10, and alterations, by the driver of the subject vehicle 10, to vehicle operating conditions including, but not limited to, steering angle, braking and acceleration.

If the driver of the subject vehicle 10 does not acknowledge the displayed informational notification 62, the system controller 34 is adapted to augment the displayed informational notification 62 to help draw the attention of the driver 80 to the displayed informational notification 62. Augmentation may include changing the confidence level, and color coding of the displayed informational notification 62, addition of graphics, addition of an audible informational notification 62A, or increasing the volume of an audible informational notification 62A that is already being broadcast.

After displaying the informational notification 62, the system controller 34 determines if display of an action notification 72 along with the informational notification 62 is appropriate. The action notification 72 is a message including text and/or graphics displayed on the HMI 58 for the driver 80 of the subject vehicle 10 and is adapted to, when the subject vehicle 10 is being operated in autonomous mode, inform the driver 80 of autonomous action that will be taken in response to the traffic situation, and, when the subject vehicle 10 is being operated in manual mode, direct the driver 80 to take action in response to the traffic situation.

Referring again to FIG. 3 and to FIG. 4, the subject vehicle 10 is moving within the right lane 64A within the roadway 64 and the system controller 34 detects, with the plurality of sensors 40a-40n, the presence of a traffic situation (pothole 66, slow-moving truck 68) within the right lane 64A within the path of the subject vehicle 10. The system controller 34 determines that display of an action notification 72 is appropriate when the proximity of the subject vehicle 10 to the traffic situation, and the nature of the traffic situation dictates that an action notification 72 is appropriate. The action notification 72 is adapted to, notify the driver 80 of the subject vehicle 10 that a maneuver, such as changing lanes, slowing down or hard braking is necessary due to the presence and proximity of the traffic situation, or to reassure the driver 80 of the subject vehicle 10 that no action is necessary as the subject vehicle 10 approaches the traffic situation. If the subject vehicle 10 is being operated in a manual mode, the action notification 72 is adapted to direct the driver 80 to take the required action and if the subject vehicle 10 is being operated in an autonomous mode, the action notification 72 is adapted to provide notification to the driver 80 of the upcoming autonomous maneuver.

Further, the system controller 34 uses data stored within the data base 60, real-time data of current operating conditions of the subject vehicle 10 and the location of the subject vehicle 10 relative to the pothole 66 to determine if displaying an action notification 62 is appropriate. In an exemplary embodiment, the system controller 34 is adapted to access the machine learning model 70 that is based on driver preferences and data collected from past instances of detection of traffic situations, display of action notifications 72 and driver responses to displayed action notifications 72. The machine learning model 70 is adapted to predict that an action notification 72 is appropriate based on the real-time data related to the traffic situation (pothole 66, slow-moving truck 68) located ahead of the subject vehicle 10 and operating conditions of the subject vehicle 10.

In an exemplary embodiment, determination that the action notification 62 is appropriate is based, at least in part, on a probabilistic calculation by the machine learning model 70 that the detected traffic situation (pothole 66, slow-moving truck 68) will interfere with the current trajectory of the subject vehicle 10, and thus, will necessitate a vehicle maneuver to avoid the traffic situation. For example, when the system controller 34 detects the pothole 66 in FIG. 3, the machine learning model 68 uses data to calculate a probability that the driver 80 of the subject vehicle 10 will want to avoid hitting the pothole based on past behavior of that driver encountering such a traffic situation. Further, the system controller 34 receives information from remote entities 48, such as department of transportation databases, wherein the system controller 34 can determine that the informational notification 62 is appropriate based on information that the pothole 66 is causing damage to vehicle that have hit the pothole 66.

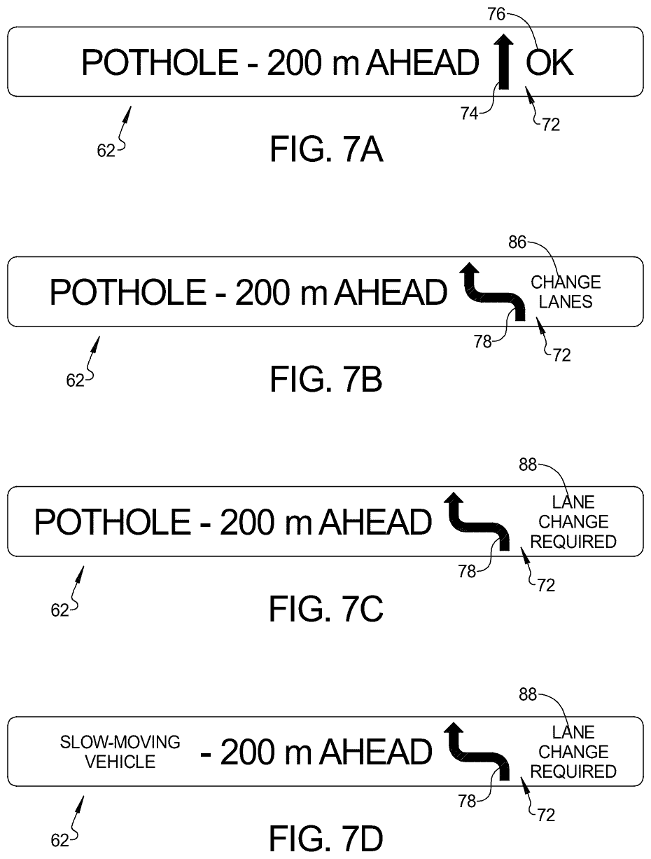

If the system controller determines that display of the action notification is appropriate, the system controller 34 displays the action notification, via the HMI 58, for the driver of the subject vehicle 10. When displaying the action notification 72, the system controller 34 is further adapted to calculate a probabilistic confidence level that the traffic situation will require a responsive maneuver by the subject vehicle 10. The displayed action notification 72 includes color coding and graphics within the action notification 72 based on the calculated probabilistic confidence level that the traffic situation will require a responsive maneuver by the subject vehicle 10. For example, if the confidence level is low, the action notification 72 may be displayed in GREEN, reassuring the driver of the subject vehicle 10 that the traffic situation does not require a maneuver and instructing the driver of the subject vehicle 10 to keep proceeding within the current lane at the current speed. Referring to FIG. 7A, the action notification 72 is displayed along with the informational notification 62 and includes a graphic arrow 74 directing the driver 80 of the subject vehicle 10 to proceed straight and text 76, indicating that the situation is “OK”. Both the arrow 74 and text 76 are displayed in GREEN. Thus, the action notification 72 provides reassurance to the driver of the subject vehicle 10 that a maneuver is not necessary. If the subject vehicle 10 is being operated in an autonomous mode, the action notification 72 shown in FIG. 7A provides notification to the driver 80 that no autonomous action will be taken by the subject vehicle 10, and the subject vehicle 10 will proceed without diversion. In this way, the driver 80 of the subject vehicle 10 is informed, reassured and not surprised.

If the confidence level is medium, the action notification 72 may be displayed in YELLOW, indicating to the driver 80 of the subject vehicle 10 that the traffic situation is more likely to require a maneuver. Referring to FIG. 7B, the action notification 72 includes an arrow 78, and text 86, indicating that changing lanes may be necessary. The action notification 72 is displayed in YELLOW to convey to the driver 80 that the confidence level is medium, and that such action may or may not be necessary, thus, drawing the driver's attention to the traffic situation and prompting the driver 80 to evaluate.

If the confidence level is high, the action notification 72 shown in FIG. 7B is displayed in RED, indicating to the driver of the subject vehicle 10 that the subject vehicle 10 must make a maneuver to avoid the traffic situation. Referring to FIG. 7C, if the confidence level is high, the content of the action notification 72 may be changed to provide a stronger message as well as being displayed in RED, alerting the driver 80 to the traffic situation and conveying that a responsive maneuver is required immediately. As shown, different text 88 has been included with the arrow 78 to stress to the driver 80 that a maneuver is necessary.

A first step in calculating a confidence level for the action notification 72 includes calculating a probability that the traffic situation will require a maneuver to avoid the traffic situation. Thus, referring again to the example with the pothole 66 discussed above, if the size/depth of the pothole 66 is small and not likely to cause damage to the subject vehicle 10, the confidence level may be calculated as medium, conveying to the driver that an avoidance maneuver is optional, wherein the action notification 72 is displayed as shown in FIG. 7B in YELLOW. If the size/depth of the pothole 66 is large and information received from remote entities 48 indicates that the pothole 66 is causing damage to vehicles, the system controller 34 probabilistically calculates a high confidence level that the pothole 66 requires a responsive maneuver by the subject vehicle 10, and displays the action notification 72, directing the driver of the subject vehicle 10 to change lanes, as shown in FIG. 7C, in RED to convey to the driver 80 that a maneuver is required. Referring again to the example with the slow-moving truck 68 discussed above, if the system controller 34 detects that the slow-moving truck 68 is moving significantly slower than the subject vehicle 10, then the subject vehicle 10 must change lanes to avoid the slow-moving truck 68, thus, the system controller 34 calculates there is a high confidence level that the subject vehicle 10 will need to make a maneuver to avoid the slow-moving truck 68, and displays the action notification 72, including the same arrow 78 and text 88 shown in FIG. 7C, directing the driver 80 of the subject vehicle 10 to change lanes, as shown in FIG. 7D, in RED to convey to the driver 80 that the maneuver is required.

A second step in calculating a confidence level for the action notification 72 includes calculating probabilities to predict if and when the driver of the subject vehicle 10 will take action. The system controller 34 uses the machine learning model 70 to analyze past instances of the driver of the subject vehicle 10 encountering such traffic situation and to predict what action that driver will want to take in response to the traffic situation and when the driver of the subject vehicle 10 will take action in calculating the confidence level and determining when to display the action notification 72. For example, for a first driver of the subject vehicle 10, the database 60 includes data from past instances of the first driver encountering the pothole 66, and in previous instances, the first driver does not take action or perform a maneuver to avoid the pothole 66, and simply drives over the pothole 66. Thus, the system controller 34, using a machine learning model tailored for the first driver, calculates a low confidence level that a maneuver will be necessary or preferred by the first driver and displays the action notification 72 shown in FIG. 7A in GREEN text to indicate such. Alternatively, for a second driver of the subject vehicle 10, the database 60 includes data from past instances of the second driver encountering the pothole 66, and in previous instances, the second driver elects to change lanes to avoid the pothole 66, always choosing to avoid the pothole 66. Thus, the system controller 34, using a machine learning model tailored for the second driver calculates a high confidence level that a maneuver will be necessary or preferred by the second driver and displays the action notification shown in FIG. 7C in RED text to indicate such. In this way, the system controller 34, using data stored for various drivers and machine learning models tailored for the various drivers provides the action notification 72 in a manner that is consistent with the driver's past behavior and preferences.

Referring again to FIG. 5, in an exemplary embodiment, when displaying the action notification 72, the system controller 34 further provides an audible action notification 72A via the speaker 82 associated with the HMI 58. The audible action notification 72A may be a chime or bell adapted to alert the driver 80 of the subject vehicle 10 that the action notification 72 has been displayed on the HMI 58, and prompting the driver 80 of the subject vehicle 10 to look at the HMI 58 to read the action notification 72. The audible action notification 72A may be an audible message mirroring the displayed action notification 72, wherein a computer synthesized voice provides an audible version of the displayed action notification 72.

In another exemplary embodiment, when the action notification 72 is displayed on the HMI 58, the system controller 34 further displays the action notification 72B onto the inner surface of the windshield of the subject vehicle 10 with the head-up-display.

Once the action notification 62 has been displayed, the system controller 34 is adapted to monitor, with the driver monitoring system 56, acknowledgment, by the driver 80 of the subject vehicle 10, of the displayed action notification 72. Using cameras, microphones and sensors included within the plurality of sensors 40a-40n and associated with the driver monitoring system 56, the system controller 34 “looks” for actions by the driver 80 of the subject vehicle 10 that indicate the driver 80 of the subject vehicle 10 has seen and reacted to the action notification 72. The system controller 34, using the driver monitoring system 56 detects head movements and hand gestures by the driver of the subject vehicle 10, verbal acknowledgment by the driver 80 of the subject vehicle 10, and, using various ones of the plurality of sensors 40a-40n, alterations, by the driver of the subject vehicle 10, to vehicle operating conditions including, but not limited to, steering angle, braking and acceleration.

If the driver of the subject vehicle 10 does not acknowledge the displayed action notification 72, the system controller 34 is adapted to augment the displayed action notification 72 to help draw the attention of the driver to the displayed action notification 72. Augmentation may include changing the confidence level, and color coding of the displayed action notification 72, addition of graphics, addition of an audible action notification 72A, or increasing the volume of an audible action notification 72A that is already being broadcast.

In an exemplary embodiment, when the driver of the subject vehicle 10 does not take action in response to the displayed action notification 72 and the subject vehicle 10 is being operated in a manual mode of operation the system controller 34 is further adapted to initiate, via the autonomous vehicle controller 52 of the automatic driving assistance system 54, autonomous take-over of the subject vehicle 10, wherein the autonomous vehicle controller 52 performs a responsive maneuver in response to the traffic situation.

In another exemplary embodiment, when the driver of the subject vehicle 10 does not take action in response to the displayed action notification 72 and the subject vehicle 10 is being operated in an autonomous mode of operation the system controller 34 is further adapted to perform, via the automatic driving assistance system 54, a responsive maneuver in response to the traffic situation.

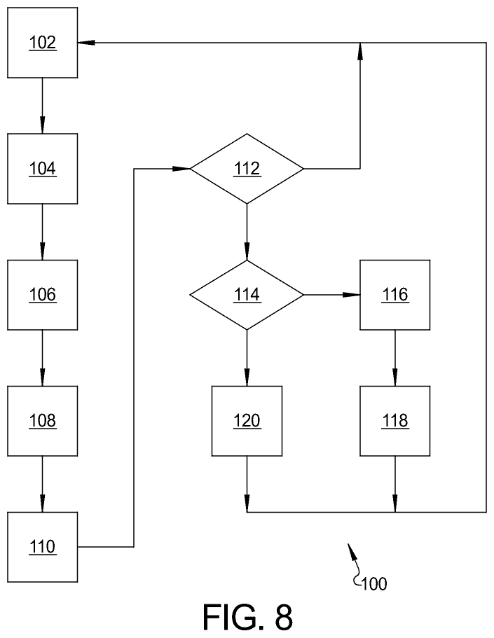

Referring to FIG. 8, a method 100 of providing notifications and vehicle control within a subject vehicle 10 in response to detected traffic situations includes, beginning at block 102, collecting, with a plurality of onboard sensors 40a-40n in communication with a system controller 34, real-time data related to a traffic situation located ahead of the subject vehicle 10 and operating conditions of the subject vehicle 10, moving to block 104, determining, with the system controller 34, that display of an informational notification 62 is appropriate, wherein the informational notification 62 is adapted to provide information to a driver 80 of the subject vehicle 10 related to the traffic situation, moving to block 106, displaying, with the system controller 34, via a human machine interface 58, the informational notification 62, moving to block 108, determining, with the system controller 34, that display of an action notification 72 is appropriate, wherein the action notification 72 is adapted to at least one of inform the driver 80 of autonomous action that will be taken in response to the traffic situation, and direct the driver 80 to take action in response to the traffic situation, and, moving to block 110, displaying, with the system controller 34, via the human machine interface 58, the action notification 72.

In an exemplary embodiment, the determining, with the system controller 34, that display of the informational notification 62 is appropriate at block 104 further includes accessing, with the system controller 34, a machine learning model 70 based on driver preferences and data collected from past instances of detection of traffic situations, display of informational notifications 62, display of action notifications 72 and driver responses to displayed informational notifications 62 and action notifications 72, and predicting, with the machine learning model 70 within the system controller 34, that an informational notification 62 is appropriate based on the real-time data related to the traffic situation located ahead of the subject vehicle 10 and operating conditions of the subject vehicle 10.

In another exemplary embodiment, the displaying, with the system controller 34, via the human machine interface 58, the informational notification 62 at block 106 further includes calculating a probabilistic confidence level that the traffic situation will require a responsive maneuver by the subject vehicle 10, and including color coding and graphics within the informational notification 62 based on the calculated probabilistic confidence level that the traffic situation will require a responsive maneuver by the subject vehicle 10.

In another exemplary embodiment, the displaying, with the system controller 34, via the human machine interface 58, the informational notification 62 at block 106 further includes displaying the informational notification 62 including a description of the traffic situation and a distance to the traffic situation.

In another exemplary embodiment, the displaying, with the system controller 34, via the human machine interface 58, the informational notification 62 at block 106 further includes monitoring, with a driver monitoring system 56 in communication with the system controller 34, acknowledgment, by the driver 80 of the subject vehicle 10, of the displayed informational notification 62, and if the driver 80 of the subject vehicle 10 does not acknowledge the displayed informational notification 62, augmenting the displayed informational notification 62.

In an exemplary embodiment, the monitoring, with the driver monitoring system 56 in communication with the system controller 34, acknowledgment, by the driver 80 of the subject vehicle 10, of the displayed informational notification 62 further includes, monitoring, with the driver monitoring system 56, head movements and hand gestures by the driver 80 of the subject vehicle 10, verbal acknowledgment by the driver 80 of the subject vehicle 10, and alterations, by the driver 80 of the subject vehicle 10, to vehicle operating conditions including, but not limited to, steering angle, braking and acceleration.

In another exemplary embodiment, the determining, with the system controller 34, that display of an action notification 72 is appropriate at block 108 further includes accessing, with the system controller 34, the machine learning model 70 based on driver preferences and data collected from past instances of detection of traffic situations, display of informational notifications 62, display of action notifications 72 and driver responses to displayed informational notifications 62 and action notifications 72, and predicting, with the machine learning model 70 that an action notification 72 is appropriate based on the real-time data related to the traffic situation located ahead of the subject vehicle 10 and operating conditions of the subject vehicle 10.

In another exemplary embodiment, the displaying, with the system controller 34, via the human machine interface 58, the action notification 72 at block 110 further includes calculating a probabilistic confidence level that an immediate responsive maneuver by the subject vehicle 10 in response to the traffic situation is required, and including color coding and graphics within the action notification 72 based on the calculated probabilistic confidence level that an immediate responsive maneuver by the subject vehicle 10 in response to the traffic situation is required.

In another exemplary embodiment, the displaying, with the system controller 34, via the human machine interface 58, the action notification 72 at block 110 further includes displaying the action notification including a textual and graphical description of the required responsive maneuver.

In another exemplary embodiment, the displaying, with the system controller 34, via the human machine interface 58, the action notification 72 at block 110 further includes monitoring, with the driver monitoring system 56 and the plurality of sensors 40a-40n within the subject vehicle 10, action taken in response to the displayed action notification 72, and if the driver of the subject vehicle 10 does not take action in response to the displayed action notification 72, augmenting the displayed action notification 72.

In an exemplary embodiment, the monitoring, with the driver monitoring system 56 and the plurality of sensors 40a-40n within the subject vehicle 10, action taken in response to the displayed action notification 72 further includes, monitoring, with the driver monitoring system, head movements and hand gestures by the driver 80 of the subject vehicle 10, verbal acknowledgment by the driver 80 of the subject vehicle 10, and alterations, by the driver 80 of the subject vehicle 10, to vehicle operating conditions including, but not limited to, steering angle, braking and acceleration.

In another exemplary embodiment, if, at block 112, the driver 80 of the subject vehicle 10 does not take action in response to the displayed action notification 72, and, at block 114 the subject vehicle 10 is being operated in a manual mode of operation, the method 100 further includes, moving to block 116, initiating, with the system controller 34, via an automatic driving assistance system 54, autonomous take-over of the subject vehicle 10, and, moving to block 118, performing, with the system controller 34, via the automatic driving assistance system 54, a responsive maneuver in response to the traffic situation. Wherein, the method 100 reverts back to block 102.

In yet another exemplary embodiment, when, at block 112, the driver 80 of the subject vehicle 10 does not take action in response to the displayed action notification 72 and, at block 114, the subject vehicle 10 is being operated in an autonomous mode of operation, the method 100 further includes, moving to block 120, performing, with the system controller 34, via the automatic driving assistance system 54, a responsive maneuver in response to the traffic situation. Wherein, the method 100 reverts back to block 102.

A system 50 and method 100 of the present disclosure offers the advantage of providing an informational notification 62 to inform a driver 80 of a subject vehicle 10 of a traffic situation ahead of the subject vehicle 10, determining if and when to display the informational notification 62 and a confidence level of the informational notification 62 based on a probabilistic calculation that the traffic situation may require a maneuver and using a machine learning model 70 to predict a driver's preferences based on past behaviors. Further, the system 50 and method 100 of the present disclosure offers the advantage of providing an action notification 72 to inform and/or direct a driver 80 of a subject vehicle 10 of action to be taken in response to the traffic situation ahead of the subject vehicle 10, determining if and when to display the action notification 72 and a confidence level of the action notification 62 based on a probabilistic calculation that the traffic situation may require a maneuver and using the machine learning model 70 to predict a driver's preferences based on past behaviors. Thus, the system 50 and method 100 of the present disclosure provides informational notifications 62 and action notifications 72 based on both empirical real time data and probabilities based on past instances to provide informational notifications 62 and action notifications 72 that are useful and are displayed in a manner tailored for a specific driver 80 of the subject vehicle 10. The system 50 and method 100 of the present disclosure provides for informing and directing actions of the driver 80, and when the driver 80 fails to respond or when the subject vehicle 10 is being operated in an autonomous mode of operation, the system 50 automatically initiates an appropriate maneuver of the subject vehicle 10 in response to the detected traffic situation.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of providing notifications and vehicle control within a subject vehicle in response to detected traffic situations, comprising:
collecting, with a plurality of onboard sensors in communication with a system controller, real-time data related to a traffic situation located ahead of the subject vehicle and operating conditions of the vehicle;
determining, with the system controller, that display of an informational notification is appropriate, wherein the informational notification is adapted to provide information to a driver of the subject vehicle related to the traffic situation;
displaying, with the system controller, via a human machine interface, the informational notification;
determining, with the system controller, that display of an action notification is appropriate, wherein the action notification is adapted to at least one of:
inform the driver of autonomous action that will be taken in response to the traffic situation; and
direct the driver to take action in response to the traffic situation; and
displaying, with the system controller, via the human machine interface, the action notification.

2. The method of claim 1 wherein the determining, with the system controller, that display of the informational notification is appropriate further includes:
accessing, with the system controller, a machine learning model based on driver preferences and data collected from past instances of detection of traffic situations, display of informational notifications, display of action notifications and driver responses to displayed informational notifications and action notifications; and
predicting, with the machine learning model within the system controller, that an informational notification is appropriate based on the real-time data related to the traffic situation located ahead of the subject vehicle and operating conditions of the subject vehicle.

3. The method of claim 2, wherein the displaying, with the system controller, via the human machine interface, the informational notification further includes:
calculating a probabilistic confidence level that the traffic situation will require a responsive maneuver by the subject vehicle; and
including color coding and graphics within the informational notification based on the calculated probabilistic confidence level that the traffic situation will require a responsive maneuver by the subject vehicle.

4. The method of claim 3, wherein the displaying, with the system controller, via the human machine interface, the informational notification further includes displaying the informational notification including a description of the traffic situation and a distance to the traffic situation.

5. The method of claim 4, wherein the displaying, with the system controller, via the human machine interface, the informational notification further includes:
monitoring, with an driver monitoring system in communication with the system controller, acknowledgment, by the driver of the subject vehicle, of the displayed informational notification; and
if the driver of the subject vehicle does not acknowledge the displayed informational notification, augmenting the displayed informational notification.

6. The method of claim 5, wherein the monitoring, with an driver monitoring system in communication with the system controller, acknowledgment, by the driver of the subject vehicle, of the displayed informational notification further includes, monitoring, with the driver monitoring system, head movements and hand gestures by the driver of the subject vehicle, verbal acknowledgment by the driver of the subject vehicle, and alterations, by the driver of the subject vehicle, to vehicle operating conditions including, but not limited to, steering angle, braking and acceleration.

7. The method of claim 1 wherein the determining, with the system controller, that display of an action notification is appropriate further includes:
accessing, with the system controller, the machine learning model based on driver preferences and data collected from past instances of detection of traffic situations, display of informational notifications, display of action notifications and driver responses to displayed informational notifications and action notifications; and
predicting, with the machine learning model that an action notification is appropriate based on the real-time data related to the traffic situation located ahead of the subject vehicle and operating conditions of the vehicle.

8. The method of claim 7, wherein the displaying, with the system controller, via the human machine interface, the action notification further includes:
calculating a probabilistic confidence level that an immediate responsive maneuver by the subject vehicle in response to the traffic situation is required; and
including color coding and graphics within the action notification based on the calculated probabilistic confidence level that an immediate responsive maneuver by the subject vehicle in response to the traffic situation is required.

9. The method of claim 8, wherein the displaying, with the system controller, via the human machine interface, the action notification further includes displaying the action notification including a textual and graphical description of the required responsive maneuver.

10. The method of claim 9, wherein the displaying, with the system controller, via the human machine interface, the action notification further includes:
monitoring, with the driver monitoring system and the plurality of sensors within the subject vehicle, action taken in response to the displayed action notification; and
if the driver of the subject vehicle does not take action in response to the displayed action notification, augmenting the displayed action notification.

11. The method of claim 10, wherein the monitoring, with the driver monitoring system and the plurality of sensors within the subject vehicle, action taken in response to the displayed action notification further includes, monitoring, with the driver monitoring system, head movements and hand gestures by the driver of the subject vehicle, verbal acknowledgment by the driver of the subject vehicle, and alterations, by the driver of the subject vehicle, to vehicle operating conditions including, but not limited to, steering angle, braking and acceleration.

12. The method of claim 11, further including, when the driver of the subject vehicle does not take action in response to the displayed action notification and the subject vehicle is being operated in a manual mode of operation:
initiating, with the system controller, via an automatic driving assistance system, autonomous take-over of the subject vehicle; and
performing, with the system controller, via the automatic driving assistance system, a responsive maneuver in response to the traffic situation.

13. The method of claim 11, further including, when the driver of the subject vehicle does not take action in response to the displayed action notification and the subject vehicle is being operated in an autonomous mode of operation, performing, with the system controller, via the automatic driving assistance system, a responsive maneuver in response to the traffic situation.

14. A system for providing notifications and vehicle control within a subject vehicle in response to detected traffic situations, comprising:
a system controller,
a plurality of onboard sensors in communication with the system controller and adapted to collect real-time data related to a traffic situation located ahead of the subject vehicle and operating conditions of the vehicle;
the system controller adapted to:
determine that display of an informational notification is appropriate, wherein the informational notification is adapted to provide information to a driver of the subject vehicle related to the traffic situation;
display, via a human machine interface, the informational notification;
determine that display of an action notification is appropriate, wherein the action notification is adapted to at least one of:
inform the driver of autonomous action that will be taken in response to the traffic situation; and
direct the driver to take action in response to the traffic situation; and
display, via the human machine interface, the action notification.

15. The system of claim 14 wherein when determining that display of the informational notification is appropriate, the system controller is further adapted to:
access a machine learning model based on driver preferences and data collected from past instances of detection of traffic situations, display of informational notifications, display of action notifications and driver responses to displayed informational notifications and action notifications; and
predict, with the machine learning model within the system controller, that an informational notification is appropriate based on the real-time data related to the traffic situation located ahead of the subject vehicle and operating conditions of the subject vehicle.

16. The system of claim 15, wherein when displaying, via the human machine interface, the informational notification, the system controller is further adapted to:
calculate a probabilistic confidence level that the traffic situation will require a responsive maneuver by the subject vehicle;
include color coding and graphics within the informational notification based on the calculated probabilistic confidence level that the traffic situation will require a responsive maneuver by the subject vehicle and including a description of the traffic situation and a distance to the traffic situation;
monitor, with a driver monitoring system in communication with the system controller, acknowledgment, by the driver of the subject vehicle, of the displayed informational notification including head movements and hand gestures by the driver of the subject vehicle, verbal acknowledgment by the driver of the subject vehicle, and alterations, by the driver of the subject vehicle, to vehicle operating conditions including, but not limited to, steering angle, braking and acceleration; and
if the driver of the subject vehicle does not acknowledge the displayed informational notification, augment the displayed informational notification.

17. The system of claim 16 wherein when determining that display of an action notification is appropriate, the system controller is further adapted to:
access the machine learning model; and
predict, with the machine learning model that an action notification is appropriate based on the real-time data related to the traffic situation located ahead of the subject vehicle and operating conditions of the vehicle.

18. The system of claim 17, wherein when displaying, via the human machine interface, the action notification, the system controller is further adapted to:
calculate a probabilistic confidence level that an immediate responsive maneuver by the subject vehicle in response to the traffic situation is required;
include color coding and graphics within the action notification based on the calculated probabilistic confidence level that an immediate responsive maneuver by the subject vehicle in response to the traffic situation is required and including a textual and graphical description of the required responsive maneuver;
monitor, with the driver monitoring system and the plurality of sensors within the subject vehicle, action taken in response to the displayed action notification including head movements and hand gestures by the driver of the subject vehicle, verbal acknowledgment by the driver of the subject vehicle, and alterations, by the driver of the subject vehicle, to vehicle operating conditions including, but not limited to, steering angle, braking and acceleration; and
if the driver of the subject vehicle does not take action in response to the displayed action notification, augment the displayed action notification.

19. The system of claim 18, wherein, when the driver of the subject vehicle does not take action in response to the displayed action notification and the subject vehicle is being operated in a manual mode of operation the system controller is further adapted to:
initiate, via an automatic driving assistance system, autonomous take-over of the subject vehicle; and
perform, via the automatic driving assistance system, a responsive maneuver in response to the traffic situation; and
when the driver of the subject vehicle does not take action in response to the displayed action notification and the subject vehicle is being operated in an autonomous mode of operation the system controller is further adapted to perform, via the automatic driving assistance system, a responsive maneuver in response to the traffic situation.

20. An autonomous vehicle having a system for providing notifications and vehicle control within a subject vehicle in response to detected traffic situations, comprising:
a system controller,
a plurality of onboard sensors in communication with the system controller and adapted to collect real-time data related to a traffic situation located ahead of the subject vehicle and operating conditions of the vehicle;
the system controller adapted to:
access a machine learning model based on driver preferences and data collected from past instances of detection of traffic situations, display of informational notifications, display of action notifications and driver responses to displayed informational notifications and action notifications;
predict, with the machine learning model within the system controller, that an informational notification is appropriate based on the real-time data related to the traffic situation located ahead of the subject vehicle and operating conditions of the subject vehicle, wherein the informational notification is adapted to provide information to a driver of the subject vehicle related to the traffic situation;
calculate a probabilistic confidence level that the traffic situation will require a responsive maneuver by the subject vehicle;
display, via a human machine interface, the informational notification including color coding and graphics within the informational notification based on the calculated probabilistic confidence level that the traffic situation will require a responsive maneuver by the subject vehicle and including a description of the traffic situation and a distance to the traffic situation;
monitor, with a driver monitoring system in communication with the system controller, acknowledgment, by the driver of the subject vehicle, of the displayed informational notification including head movements and hand gestures by the driver of the subject vehicle, verbal acknowledgment by the driver of the subject vehicle, and alterations, by the driver of the subject vehicle, to vehicle operating conditions including, but not limited to, steering angle, braking and acceleration, and if the driver of the subject vehicle does not acknowledge the displayed informational notification, augment the displayed informational notification;
access the machine learning model;
predict, with the machine learning model that an action notification is appropriate based on the real-time data related to the traffic situation located ahead of the subject vehicle and operating conditions of the subject vehicle;
calculate a probabilistic confidence level that an immediate responsive maneuver by the subject vehicle in response to the traffic situation is required;
display, via the human machine interface, an action notification including color coding and graphics within the action notification based on the calculated probabilistic confidence level that an immediate responsive maneuver by the subject vehicle in response to the traffic situation is required and including a textual and graphical description of the required responsive maneuver, wherein the action notification is adapted to at least one of:
inform the driver of autonomous action that will be taken in response to the traffic situation; and
direct the driver to take action in response to the traffic situation;
monitor, with the driver monitoring system and the plurality of sensors within the subject vehicle, action taken in response to the displayed action notification including head movements and hand gestures by the driver of the subject vehicle, verbal acknowledgment by the driver of the subject vehicle, and alterations, by the driver of the subject vehicle, to vehicle operating conditions including, but not limited to, steering angle, braking and acceleration, and if the driver of the subject vehicle does not take action in response to the displayed action notification, augment the displayed action notification;
wherein, when the driver of the subject vehicle does not take action in response to the displayed action notification and the subject vehicle is being operated in a manual mode of operation the system controller is further adapted to initiate, via an automatic driving assistance system, autonomous take-over of the subject vehicle, and perform, via the automatic driving assistance system, a responsive maneuver in response to the traffic situation; and
when the driver of the subject vehicle does not take action in response to the displayed action notification and the subject vehicle is being operated in an autonomous mode of operation the system controller is further adapted to perform, via the automatic driving assistance system, a responsive maneuver in response to the traffic situation.
